(19) United States
(12) Patent Application Publication
(10) Pub. No.: US 2023/0413859 A1
(43) Pub. Date: Dec. 28, 2023

(54) WILD SONGBIRD FEED PRODUCTS

(71) Applicant: TBS Innovations LLC, Simpsonville, SC (US)

(72) Inventor: Timothy W. O'Tool, Simpsonville, SC (US)

(21) Appl. No.: 17/808,608

(22) Filed: Jun. 24, 2022

(51) Int. Cl. A23K 40/25; A23K 40/30; A23K 20/158; A23K 20/163; A23K 20/147; A23K 50/70; A23K 10/30

(52) U.S. Cl. CPC A23K 40/25; A23K 40/30; A23K 20/158; A23K 20/163; A23K 20/147; A23K 50/70; A23K 10/30

(57) ABSTRACT

A wild bird feed product is made by cold co-extrusion so as to produce a soft inner core encapsulated in a hard outer shell. Both the core and shell are made of edible ingredients and formulated so as to attract a variety of birds. The shell provides structural strength for the soft inner core and provides weather resistance for the feed product, while the high-fat content inner core remains soft, even in cold-weather environments. The feed product provides necessary nutrition for the birds, including fat, sugar, protein, and other supplements.

### FIELD OF THE INVENTION

The present invention is directed toward cold-extruded nutritional feed products for wild songbirds.

### BACKGROUND OF THE INVENTION

The nutritional and dietary needs of wild songbirds are significantly different than caged birds. Songbirds who live outdoors need a higher level of fat than indoor caged birds. The fat provides energy for the high activity level of the wild birds. In cold temperatures fat provides energy necessary for shivering, which wild birds do to stay warm for survival. For example, a black-cap chickadee weighs less than half an ounce, and can maintain a body temperature of 100° F., even when ambient air temperature is 0° F. Wild birds inherently have a higher metabolism than indoor, pet songbirds. Caged birds need less fat in their diet since they have less activity.

Fat is also essential for coloration of wild songbird feathers, which helps attract a mate when the bird matures. Also, young birds need fats to grow strong feathers for proper flight and effective insulation during cold temperatures.

Fat in bird feed also improves the palatability of the feed, making the feed more appetizing to the wild birds.

However, high fat-content feed is relatively soft, and thus difficult to handle. Such feed also may breakdown in higher temperatures and be washed away or dissolved by heavy rain.

Therefore, a primary objective of the present invention is the provision of a feed product, morsel, or nugget having an outer edible shell and a high-fat inner core for feeding wild songbirds.

Another objective of the present invention is the provision of a high-fat content food product for wild birds having an edible protective coating.

Still another objective of the present invention is the provision of a cold extruded wild bird feed morsel with high nutritional value.

Yet another objective of the present invention is the provision of wild bird feed product which is cold extruded to maintain and preserve sugar profiles naturally found in the feed ingredients.

Still another objective of the present invention is a provision of a two layer feed product for wild birds which is formed without drying the product.

Another objective of the present invention is the provision of a wild bird food product having an edible outer shell to provide structural strength to the product, and a soft inner core of high-fat material to provide nutritional energy for the birds.

These and other objectives become apparent from the following description of the invention.

### SUMMARY OF THE INVENTION

The wild bird feed product, morsel or nugget of the present invention is formed by cold co-extrusion so as to have an inner core surrounded by an outer shell. Both the inner core and the outer shell are edible by the wild birds. The inner core contains high-fat material to provide nutritional nourishment and energy for the bird, while the outer shell provides structural strength, and is dry to the touch for easy handling. The cold extrusion process maintains the natural sugars in the soft fat material. The food product can be used outdoors, while maintaining structural integrity in high temperatures and wet conditions, while retaining the soft inner core in cold temperatures. The product can be formed in various shapes, including rectangular blocks, and cylinders. The product includes high-fat, protein, and sugar content, as well as other nutritional supplements.

### BRIEF DESCRIPTION OF THE DRAWINGS

FIG. 1 is a perspective view of a first embodiment of the present invention, in the form of a square co-extruded feed product for wild songbirds.

FIG. 2 is a sectional view taken along lines 2-2 of FIG. 1.

FIG. 3 is a perspective view of a second embodiment of the wild songbird feed product, in a rectangular co-extruded form, according to the present invention.

FIG. 4 is a sectional view taken along lines 4-4 of FIG. 3.

FIG. 5 is a perspective view of a third embodiment of the wild songbird feed product, in a cylindrical co-extruded form, according to present invention.

FIG. 6 is a sectional view taken along lines 6-6 of FIG. 5.

FIG. 7 is a perspective view with a cut away showing a fourth embodiment of the wild songbird feed, in a spherical form, according to the present invention.

### DETAILED DESCRIPTION OF THE INVENTION

The wild songbird feed product is generally in the form of a nugget or product 10. The product can take various shapes, all of which include an inner core 12 and an outer shell 14. The core 12 and the shell 14 are both edible by the bird. The core 12 and outer shell 14 may each be made with various ingredients to create formulations that attract different varieties of birds. Preferably, the core 12 and shell 14 use different ingredients, at least in part, so as to have two different flavors, both of which are attractive to wild songbirds.

The core 12 and the shell 14 of the feed product 10 can both include fat, which provides energy for the bird. The core 12 has a higher fat level than the shell 14, such that the core is relatively soft, regardless of the ambient temperature. The shell 14 encapsulates the core 12 and is relatively firm or hard for easy handling. The shell 14 provides a weather resistant coating for the core 12. Thus, the shell 14 can withstand high and low ambient temperatures, as well as rain and snow. The hard shell 14 allows a user to place the feed product in desired locations, without touching the soft and/or sticky inner core 12. The shell 14 provides structural strength to support the high fat material in the core 12, which is naturally very soft and has limited structural integrity.

The formulations for the core 12 and the shell 14 may vary between different feed products 10, so as to attract varieties of species of birds, such as insectivores, granivores, omnivores, carnivores, and soft billed birds. The ingredients for the core 12 and the shell 14 may include grains, such as corn, oats, rye, wheat, and nuts, such as peanuts and other tree nuts, fats, including vegetable and animal fats, vegetable oils, fruits, milo, seeds, such as millet, sunflowers, safflowers, canary, caraway, flax, rape and nyjer, peanut butter, jelly, vitamins, minerals, and antioxidants and other supplements. Also, mold inhibitors can be included in the formulations to extend the useful life of the feed product 10.

Preferably, the feed product 10 is manufactured by cold co-extrusion of the inner core 12 and the outer shell 14, at or near room temperatures. Cold extrusion may include forward, backward, and lateral extrusion, with forward extrusion being preferred. The cold extrusion process allows the starting material, in the form of a billet or slug, to be at room temperature, for flow through the co-extensive extrusion inner and outer tubes. The cold extrusion process maintains the temperature of the material below its re-crystallization temperature, and eliminates conversion of natural sugars in the feed ingredients. Also, with cold extrusion, drying of the finished product is not necessary. The cold extrusion process also eliminates the use of water, and thereby eliminates or minimizes mold issues, which can be present in extrusion processes which utilize water.

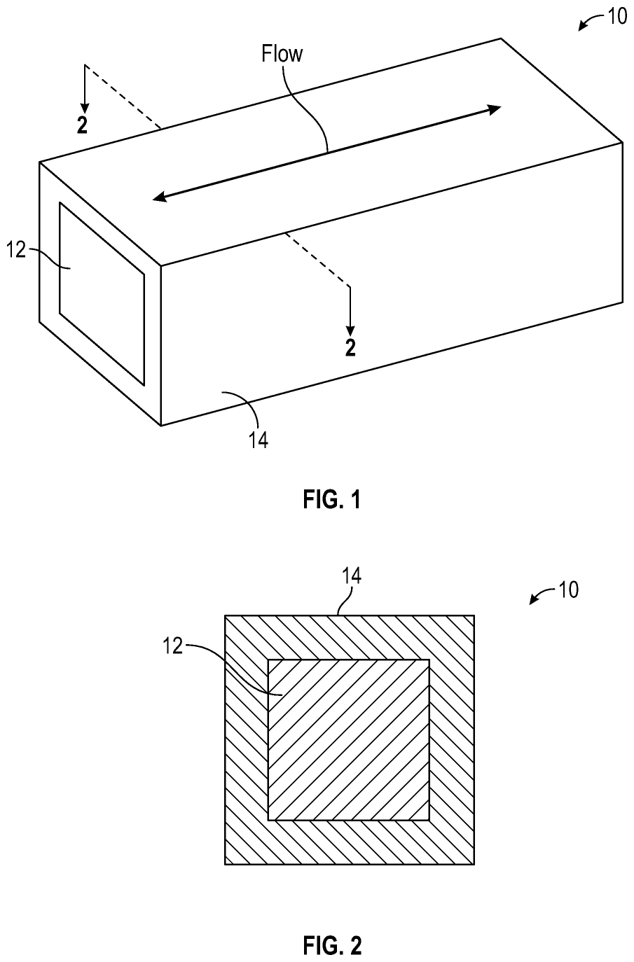

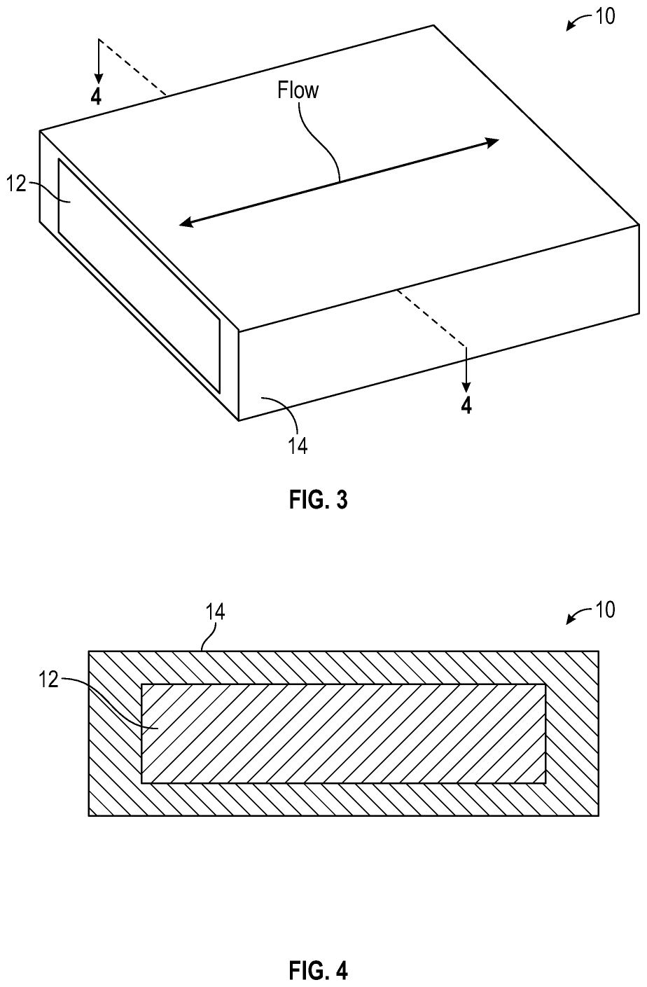

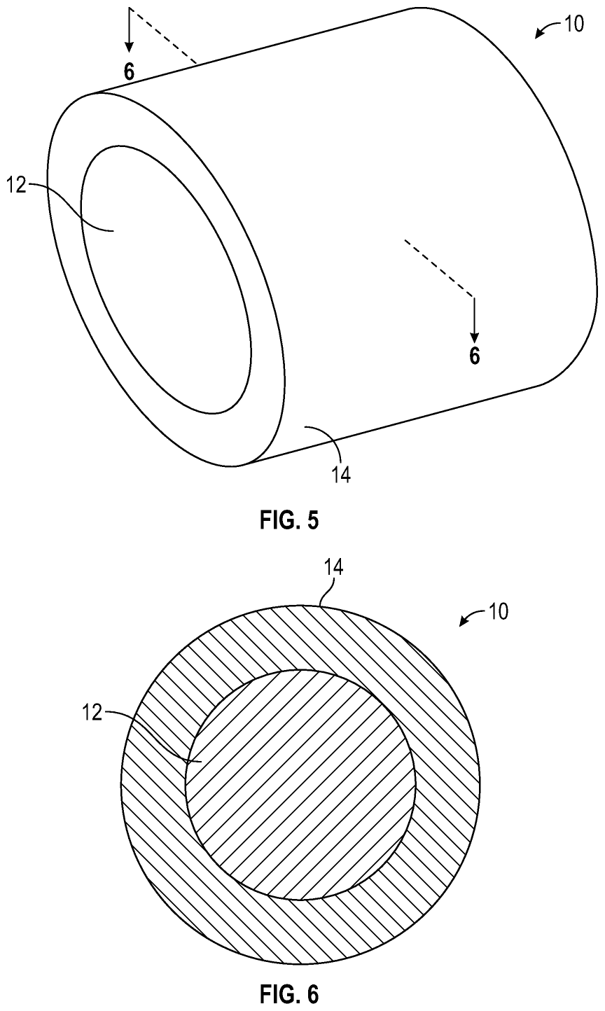

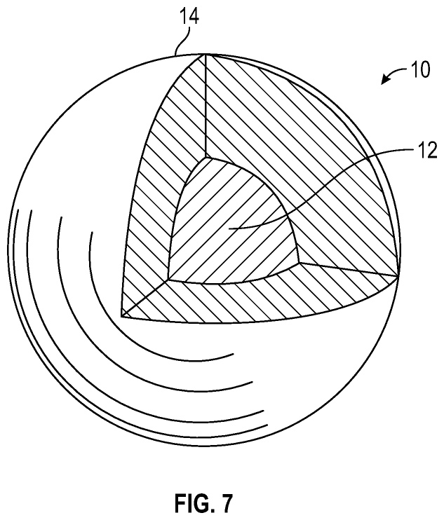

The cold extrusion process may produce various shapes for the feed product 10, As shown in FIGS. 1-6. For example, the product 10 may have a square cross-section (FIGS. 1 and 2), rectangular cross-section (FIGS. 3 and 4), or cylindrical cross-section (FIGS. 5 and 6). In a further embodiment, the feed product may have a spherical shape (FIG. 7), which is not made by a co-extrusion process.

The cold extrusion process thus yields a wild songbird feed product 10 which is high in fat content, sugar content, protein content and other nutritional supplements. The product or nugget 10 is also easy to handle and weather resistant. The product 10 can be formulated to attract various species of birds. Wild birds more readily accept these cold extruded products 10 due to the soft nature of the finished product.

Examples of ingredients for the core 12 and the shell 14 are provided in the following tables, wherein various ingredients for the inner core are listed in Examples 1-3, and various ingredients for the outer shell are listed in Examples 4-7. The inner cores and outer shells can be combined from any of the examples, and other variations of these formulations.

Inner Materials
Example 1: Peanut Paste

| | |
|---|---|
| Fat | 28.8% |
| Fat Supplement | 3.2% |
| Ground Corn | 51.7% |
| Peanut Butter | 12.0% |
| Chipped Peanuts | 4.0% |
| Preservative | 0.3% |
| | 100.0% |

Example 2: Berry Paste

| | |
|---|---|
| Fat | 28.8% |
| Fat Supplement | 3.2% |
| Ground Corn | 50.0% |
| Peanut Butter | 11.2% |
| Colorant (if needed) | 2.0% |
| Fruit | 4.5% |
| Preservative | 0.3% |
| | 100.0% |

Example 3: Hot Pepper Paste

| | |
|---|---|
| Fat | 28.8% |
| Fat Supplement | 3.2% |
| Ground Corn | 50.5% |
| Peanut Butter | 12.0% |
| Oleo Resin Pepper | 1.8% |
| Chipped Peanuts | 3.4% |
| Preservative | 0.3% |
| | 100.0% |

Outer Materials
Example 4: Nuts and Berry

| DESCRIPTION | |
|---|---|
| Ground Oats/Wheat | 11.8% |
| Ground Corn | 42.2% |
| Fat | 11.0% |
| Oil | 0.8% |
| Small Roasted Peanut Pieces | 7.1% |
| Ground Peanuts | 25.0% |
| Preservative | 0.3% |
| Fruit | 1.8% |
| | 100.0% |

Example 5: Woodpecker

| DESCRIPTION | |
|---|---|
| Ground Oats/Wheat | 11.6% |
| Ground Corn | 42.1% |
| Oil | 0.8% |
| Fat | 11.0% |
| Tree Nuts | 7.9% |
| Ground Peanuts | 26.3% |
| Preservative | 0.3% |
| | 100% |

Example 6: Hot Pepper

| DESCRIPTION | |
|---|---|
| Ground Oats/Wheat | 11.8% |
| Ground Corn | 43.1% |
| Fat | 10.1% |
| Small Roasted Peanut Pieces | 7.1% |
| Ground Peanuts | 25.8% |
| Preservative | 0.3% |
| Oleo Capsicum | 1.8% |
| | 100.0% |

Example 7: Peanut

| DESCRIPTION | |
|---|---|
| Ground Oats/Wheat | 11.6% |
| Ground Corn | 44.1% |
| Oil | 0.8% |
| Fat | 9.0% |
| Small Roasted Peanut Pieces | 7.9% |
| Ground Peanuts | 26.3% |
| Preservative | 0.3% |
| | 100% |

Product 10 can also be formulated for poultry consumption. Poultry diet should be high in fat content, to allow the birds metabolism to absorb fat-soluble vitamins A, D, E and K. The nutritional nuggets 10 are particularly suitable for free range poultry, such as chickens, which are not caged or housed indoors for a majority of their lives. Birds raised primarily outdoors have higher metabolism and nutritional needs that caged or permanently housed birds, similar to wild birds compared to indoor pet birds.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of providing nutritional feed to wild songbirds, comprising:
cold co-extruding an edible inner core of a first formulation and an edible outer shell of a second formulation to form feed products, each with the out shell encapsulating the inner core, and the outer shell being resistant to deterioration in ambient weather conditions;
placing the feed nuggets outdoors whereby wild songbirds are attracted to eat the outer shell and the inner core.

2. The method of claim 1 wherein the inner core has at least 28% fat content.

3. The method of claim 2 wherein the outer shell has at least 9% fat content.

4. The method of claim 1 wherein the first and second formulations both comprise an edible fat.

5. The method of claim 4 wherein the inner core has a high fat content and the outer shell has low fat content.

6. The method of claim 1 wherein the inner core remains soft when placed in cold weather conditions and the outer shell remains firm when placed in warm weather conditions.

7. The method of claim 1 wherein the co-extruding step is forward extrusion.

8. The method of claim 1 wherein the inner core and outer shell are at room temperature during the co-extrusion process.

9. The method of claim 1 wherein the co-extrusion process is at a temperature below the crystallization temperature of the first formulation.

10. The method of claim 1 wherein the co-extrusion process is at a temperature to preclude conversion of sugars in the first food substance.

11. The method of claim 1 wherein the products are ready for placement without drying after the co-extrusion step.

12. The method of claim 1 wherein the first and second formulations are selected from a group comprising grains, nuts, oils, seeds, vitamins, minerals, and jellies.

13. A wild songbird food product comprising:
an inner core and an outer shell formed by cold co-extrusion;
the inner core and outer shell both being edible and being selected from a group comprising grains, nuts, oils, seeds, vitamins, minerals and jellies;
the inner core having a higher fat content than the outer shell; and
the inner core being soft to touch and the outer shell being firm to touch.

14. The food product of claim 13 wherein the inner core has a fat content of at least 25%.

15. The food product of claim 13 wherein the outer shell has a fat content of at least 9%.

16. The food product of claim 13 wherein the outer shell is more weather resistant than the inner core.

17. The food product of claim 13 wherein the inner core includes sugars which maintain their crystalline structure after the co-extrusion process.

18. The food product of claim 13 wherein the outer shell remains firm to touch in hot ambient weather conditions and the inner core remains soft to touch in cold weather conditions.

19. The food product of claim 13 wherein the inner core includes protein.

20. The food product of claim 13 wherein the outer shell has a geometric shape.
